(19) United States
(12) Patent Application Publication
(10) Pub. No.: US 2020/0213203 A1
(43) Pub. Date: Jul. 2, 2020

(54) DYNAMIC NETWORK HEALTH MONITORING USING PREDICTIVE FUNCTIONS

(71) Applicant: Cisco Technology, Inc., San Jose, CA (US)

(72) Inventors: Magnus Mortensen, Cary, NC (US); Jay Kemper Johnston, Raleigh, NC (US); David C. White, JR., St. Petersburg, FL (US)

(21) Appl. No.: 16/238,027

(22) Filed: Jan. 2, 2019

(51) Int. Cl. H04L 12/24; G06N 5/02; H04L 12/26

(52) U.S. Cl. CPC H04L 41/147; G06N 5/02; H04L 41/20; H04L 43/14; H04L 43/08

(57) ABSTRACT

Techniques for dynamic health monitoring of a client system using predictive functions are presented. In one embodiment, a method includes obtaining a dataset associated with devices of a client system. The dataset is applied to a code module to generate a diagnostic result. The code module is configured to process the dataset to detect a potential problem associated with the devices as the diagnostic result. The method also includes generating a predictive function based on the diagnostic result from the code module. The predictive function maps an input variable associated with the diagnostic result for the potential problem to at least one of the diagnostic result or an associated severity level for the diagnostic result. The method further includes providing the predictive function to the client system for dynamically monitoring and predicting potential problems with the devices based on changes to the input variable.

### TECHNICAL FIELD

The present disclosure relates to problem detection and alerting systems.

### BACKGROUND

The use of automated problem detection and alerting/remediation systems enables the services support industry to transition from reactive support to proactive and preemptive support. The automated problem detection and alerting/remediation system may leverage machine consumable intellectual capital (IC) rules (e.g., software code modules) that detect and solve problems in customer devices. In some examples, problem detection engines may leverage IC rules to detect problems in customer device support data, and may run thousands of times per day. These engines may process data from many different types of devices, with each device configured differently per the customer's network.

Currently, software code modules implementing IC rules in automated problem detection and alerting/remediation systems detect problems and generate alerts when processing customer data. However, the detected problems and alerts are “one-time” results based on the IC rules at the time the data was processed or examined. Because the results are static and will not change over time, these systems are limited in their ability to provide truly predictive results.

### BRIEF DESCRIPTION OF THE DRAWINGS

FIG. 1 is a block diagram illustrating an automated problem detection and alerting system obtaining one or more datasets from a client system, according to an example embodiment.

FIG. 2 is a diagram illustrating a code module generating a predictive function based on a dataset, according to an example embodiment.

FIG. 3 is a block diagram illustrating an automated problem detection and alerting system providing one or more predictive functions to a client system, according to an example embodiment.

FIG. 4 is a diagram illustrating a predictive function generated for an example client device, according to an example embodiment.

FIG. 5 is a diagram illustrating dynamic health monitoring of a client system using predictive functions, according to an example embodiment.

FIG. 6 is a diagram illustrating generation of customized predictive functions based on characteristics of a client device, according to an example embodiment.

FIG. 7 is a block diagram of a client system using predictive functions to dynamically monitor one or more devices, according to an example embodiment.

FIG. 8 is a diagram illustrating chained predictive functions, according to an example embodiment.

FIG. 9 is a flow chart illustrating a method of generating and providing a predictive function to a client system, according to an example embodiment.

FIG. 10 is a block diagram of an apparatus that that may be configured to perform operations of the methods presented herein, according to an example embodiment.

### DESCRIPTION OF EXAMPLE EMBODIMENTS

### Overview

Techniques for dynamic health monitoring of a client system using predictive functions are presented. In an example embodiment, a computer-implemented method is provided that includes obtaining, at an automated problem detection and alerting system, at least one dataset associated with one or more devices of a client system. The at least one dataset is applied to at least one code module to generate a diagnostic result. The at least one code module is configured to process the at least one dataset to detect a potential problem associated with the one or more devices as the diagnostic result. The method also includes generating a predictive function based on the diagnostic result from the at least one code module. The predictive function maps an input variable associated with the diagnostic result for the potential problem detected by the at least one code module to at least one of the diagnostic result or an associated severity level for the diagnostic result. The method further includes providing the predictive function to the client system for dynamically monitoring and predicting potential problems with the one or more devices based on changes to the input variable.

### Example Embodiments

Presented herein are techniques for dynamic health monitoring of a client system using predictive functions. The predictive functions are generated by code modules of an automated problem detection and alerting system based on datasets associated with client devices exported from the client system. The predictive functions allow clients to monitor the devices at the client system using real-time data that may be constantly changing and/or to simulate data based on different scenarios to detect problems and/or changes to severity levels of problems without needing to re-export the datasets to the automated problem detection and alerting system for reprocessing by the code modules.

In one example, the techniques presented herein may be implemented in an automated problem detection and alerting system. At the heart of the system is an automated detection engine that receives data from a plurality of devices (e.g., configuration information/diagnostic/operating state data from a router, a support file of the current operating state from a computing device, logs from a network device such as a network switch or router, etc.), and processes the data as input for code modules that test and inspect the data to identify potential problems with the devices. The operational data (i.e., datasets) may be gathered at each device, either by a user/administrator or automatically, and exported (e.g., sent, emailed, uploaded to a website, etc.) to the automated problem detection and alerting system for processing by the code modules to generate the predictive functions. The operational data may be grouped into a single file or may be processed as a group (e.g., a zipped file of multiple types of operational data).

The code modules may be in the form of software program scripts, such as Python™ scripts. The scripts are typically run in parallel on the automated detection engine, with each script looking for a different problem in the input dataset. In some embodiments, the scripts of the code modules are coded to look for specific issues with software configuration or hardware settings in the device that generated the input dataset. The code modules output a diagnostic result that includes any issues found in the dataset back to the engine as potential problems with associated severity levels. As will be described in more detail below, the code modules also generate predictive functions that map input variables associated with the diagnostic result for the potential problem detected by the code module to the associated severity level for the diagnostic result. The automated detection engine may present the diagnostic results, such as the potential problems detected and associated severity levels, and the predictive functions to a user/administrator at the client system (e.g., via a web interface, email, etc.) or a machine/software system, such as a network management system, at the client system (e.g., via an API, or other machine to machine interface). Any of the scripts of the code modules may return a null set of diagnostic results, indicating that the issue targeted by the script was not a problem in this particular input dataset. However, according to the techniques presented herein, the code module also generates and provides a predictive function that allows the client to dynamically monitor and predict potential problems based on changes to the input dataset.

The techniques presented herein provide a mechanism for generating predictive functions by a problem detection/analysis system that are dynamic, rather than static results, which allows for different conditions to be used as inputs to the predictive functions to forecast changes to a client device and/or system.

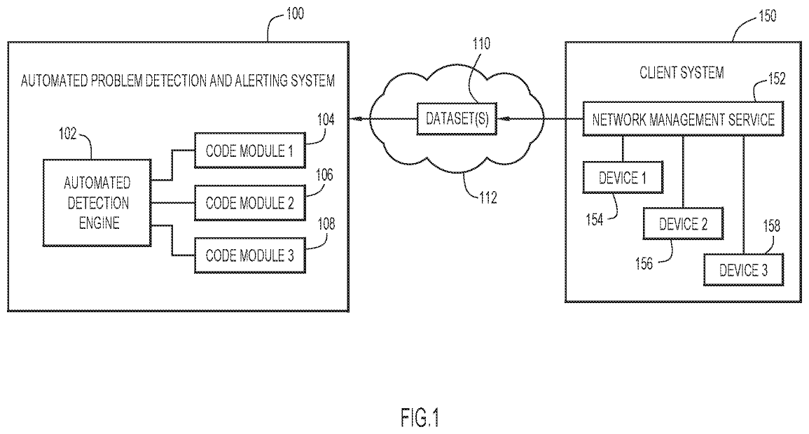

Referring now to FIG. 1, a block diagram of an automated problem detection and alerting system 100 obtaining one or more datasets 110 from a client system 150 is shown for generating predictive functions according to an example embodiment. The automated problem detection and alerting system 100 includes an automated detection engine 102 comprising a plurality of code modules that implement various IC rules. In this embodiment, the plurality of code modules include a first code module 104, a second code module 106, and a third code module 108. Each code module 104, 106, 108 includes a script or other declarative rules that are created to look for specific issues with software configurations or hardware settings in a device that generated an input dataset.

For example, in this embodiment, automated problem detection and alerting system 100 may obtain dataset 110 from client system 150. In some embodiments, one or more datasets, including dataset 110, may be obtained from client system 150 through a communication network 112 (e.g., the Internet). Datasets from client system 150 may be associated with one or more devices at client system 150. In an example embodiment, client system 150 may include a plurality of devices, including a first device 154, a second device 156, and a third device 158. The plurality of devices 154, 156, 158 may be supervised and monitored by a network management service 152 at client system 150.

In one embodiment, client system 150 is an enterprise network and the plurality of devices 154, 156, 158 may include one or more switches, routers, gateways, firewalls, access points, intrusion detection systems, Internet-of-Things (IoT) devices, and/or any other networking device (physical or virtual), computational device, or other device that generates telemetry or diagnostic data, including devices now known or hereinafter developed.

In an example embodiment, network management service 152 may monitor, gather, record, and/or transmit operational data associated with one or more of the plurality of devices 154, 156, 158. The operational data includes information about various parameters associated with plurality of devices 154, 156, 158 and may include historical and/or real-time data. The operational data may be gathered or grouped by network management service 152 and provided as one or more datasets (e.g., dataset 110) to automated problem detection and alerting system 100 for generating a predictive function.

In one embodiment, each code module 104, 106, 108 may be associated with a diagnostic result for a different potential problem with one or more devices of client system 150. In other words, each code module 104, 106, 108 may include logic or a script that is looking for a different potential problem across all of the devices in client system 150. For example, first code module 104 may be configured to detect a first potential problem with any of first device 154, second device 156, or third device 158, and second code module 106 may be configured to detect a different, second potential problem with any of first device 154, second device 156, or third device 158. Similarly, third code module 108 also may be configured to another, different potential problem (i.e., different from first code module 104 and second code module 106) with any of first device 154, second device 156, or third device 158. In other embodiments, each code module 104, 106, 108 may be associated with a diagnostic result for a same potential problem for a particular device at client system 150. In these embodiments, each code module may be associated with detecting the same potential problem in each individual device. In still other embodiments, the plurality of code modules at automated problem detection and alerting system 100 may include code modules configured for a combination of different potential problems as well as different devices.

In this embodiment, dataset 110 is associated with operational data from first device 154 and first code module 104, second code module 106, and third code module 108 are each configured to determine diagnostic results for different potential problems with first device 154.

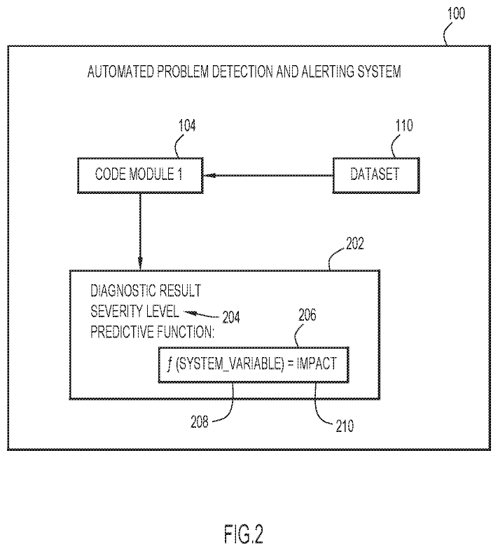

Referring now to FIG. 2, a representative code module generating a predictive function based on a dataset is shown according to an example embodiment. In this embodiment, the representative code module is first code module 104, which receives dataset 110 that includes operational data from first device 154 of client system 150, as described above. Dataset 110 is applied to first code module 104 which generates an output of a diagnostic result 202 that identifies and describes any issues found in dataset 110 as a potential problem with first device 154 and may further include an associated severity level 204 for the problem. Additionally, diagnostic result 202 may optionally include other potentially useful information associated with the potential problem, such as debugging output, different wordings or descriptions of the problems (e.g., for different audiences or users), etc. In this embodiment, diagnostic result 202 and severity level 204 are static values based on the operational data included in dataset 110 and processed by first code module 104.

In addition, according to the techniques of the present embodiment, the diagnostic result 202 that is output from first code module 104 also includes a predictive function 206. Predictive function 206 is a dynamic function that maps an input variable 208 associated with diagnostic result 202 for the potential problem with first device 154 detected by first code module 104 to at least one of diagnostic result 202 or the associated severity level 204 for diagnostic result 202. In this example, predictive function 206 includes input variable 208 (e.g., a system variable) and an output 210 (e.g., the impact or severity of the potential problem). In one embodiment, output 210 may be the impact input variable 208 has on the diagnostic result 202 and/or severity level 204 associated with the diagnostic result. In other embodiments, as will be described in more detail below, output 210 from predictive function 206 may be used as an input variable for another predictive function (i.e., chained predictive functions).

With this arrangement, automated problem detection and alerting system 100 executes one or more code modules (e.g., first code module 104) which are configured to process one or more datasets (e.g., dataset 110) to return diagnostic results for a potential problem that also include one or more predictive functions (e.g., predictive function 206). A predictive function, such as predictive function 206, may then be used by automated problem detection and alerting system 100 and/or client system 150 to perform a simulation of how changing conditions (i.e., a change to input variable 208 of predictive function 206) will affect a device (e.g., first device 154 associated with dataset 110) by feeding different values for the input variable into the predictive function. Using these predictive functions, the specific conditions that will cause the performance of a device to increase/improve or decrease/degrade can be determined for automatically adjusting client system 150 for a desired performance or diagnostic result.

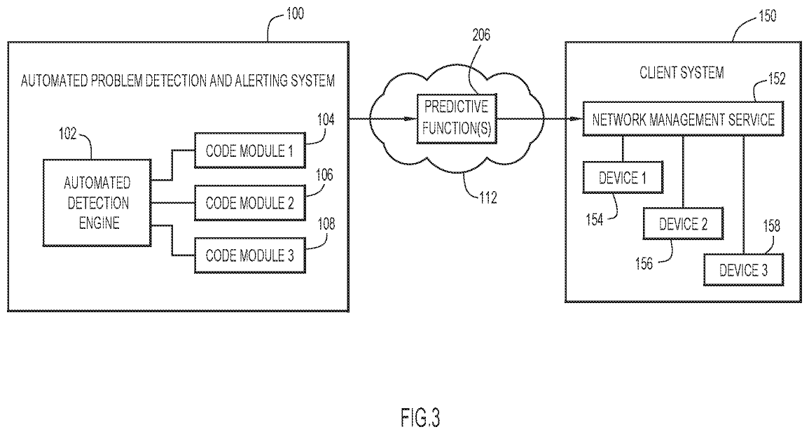

FIG. 3 illustrates automated problem detection and alerting system 100 providing one or more predictive functions 206 to client system 150, according to an example embodiment. In this embodiment, after one or more datasets, including dataset 110 for first device 104 (as shown in FIG. 1), are applied to plurality of code modules 104, 106, 108 to generate one or more predictive functions from those datasets, the generated predictive functions, including predictive function 206, are provided to client system 150. For example, predictive function 206 and any other predictive functions generated by code modules 104, 106, 108, may be provided to client system 150 through communication network 112 (e.g., the Internet).

In some embodiments, client system 150 includes network management service 152, which may be configured to monitor operational data from plurality of devices 154, 156, 158. Network management service 152 may use the one or more predictive functions obtained from automated problem detection and alerting system 100 for dynamically monitoring and predicting potential problems with the one or more devices 154, 156, 158 based on changes to input variables associated with the predictive functions. With this arrangement, client system 150 may use the predictive functions to generate updated diagnostic results and/or associated severity levels for potential problems with plurality of devices 154, 156, 158 by changing only the input variable for the predictive function and without needing to apply a new dataset to the one or more code modules at automated problem detection and alerting system 100.

In some cases, network management service 152 may monitor the operational data from plurality of devices 154, 156, 158 in real-time, including streaming data, and use parameters from the monitored data as input variables to the predictive functions. In other cases, network management service 152 may access stored or archived historical data associated with plurality of devices 154, 156, 158 as input variables to the predictive functions. In still other cases, network management service 152 may test different values of input variables to the predictive functions to simulate a potential state of one or more devices 154, 156, 158 so that a simulation of the impact of changes to plurality of devices 154, 156, 158 and/or client system 150 may be modelled or examined.

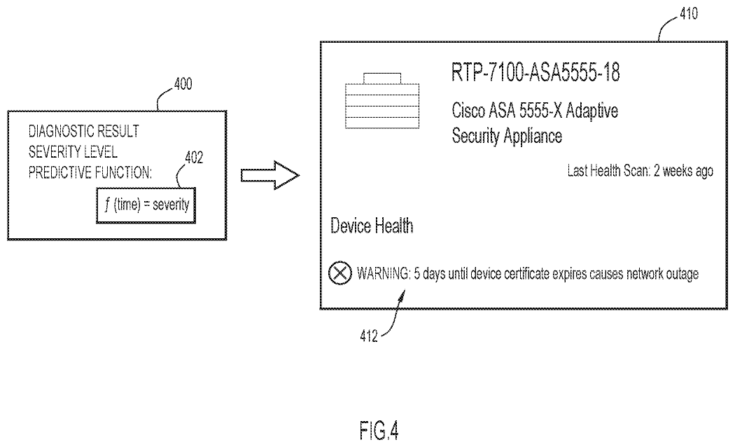

Referring now to FIG. 4, a diagram illustrating a predictive function generated for an example client device is shown according to an example embodiment. In an example embodiment, a diagnostic result 400 for any potential problems with a client device 410 includes a predictive function 402 that may be generated by a code module at automated problem detection and alerting system 100 based on a dataset from client system 150. In this embodiment, diagnostic result 400 for the health of client device 410 includes predictive function 402 that maps an input variable (e.g., time in this example) to an associated severity level of diagnostic result 400.

In a scenario using a conventional diagnostic system, the health of client device 410 is determined at the time of the diagnostic scan, which in this example was two weeks ago. At the time of that diagnostic scan, a certificate associated with client device 410 was determined to be currently valid, therefore, no severity level or alert was issued. However, because of the static nature of the diagnostic result in this scenario, the client system is not aware of an impending expiration of the certificate associated with the client device 410. That is, unless in the two weeks since the previous diagnostic scan, subsequent diagnostic scans are performed, the client system will not be alerted to the impending expiration of the certificate associated with the client device 410. Thus, the conventional diagnostic system only takes a fixed snapshot of issues at the time of scanning and does not dynamically alter or update the severity of issues detected with time.

In contrast, the techniques of the present embodiments provide a predictive function (e.g., predictive function 402) that may change the diagnostic result and/or the associated severity level based on changes to an input variable (e.g., time in the example of FIG. 4). As a result, two weeks after the initial diagnostic scan of the dataset for client device 410, predictive function 402 may now generate a warning 412 to alert the client system that the certificate associated with client device 410 will soon expire. That is, without applying a new dataset for client device 410, predictive function 402 is able to generate an updated diagnostic result and provide warning 412 to the client system of a potential problem with client device 410.

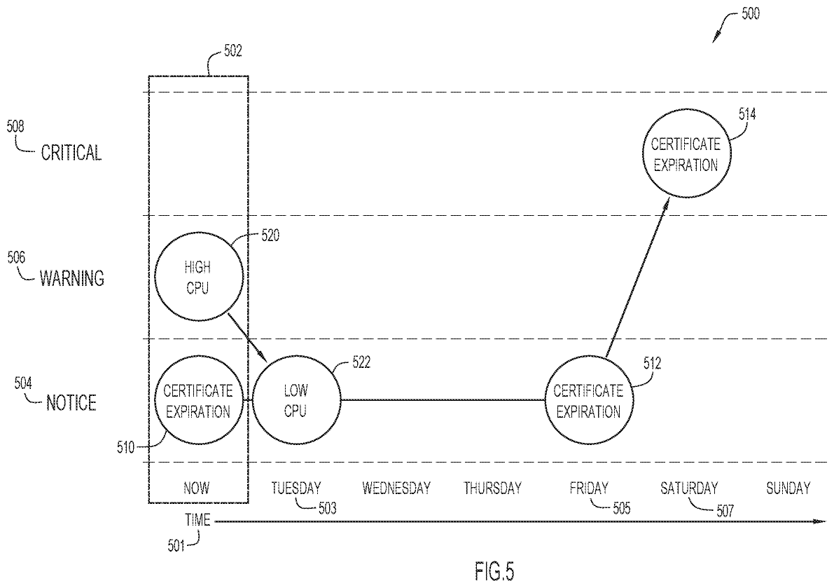

FIG. 5 is a diagram illustrating dynamic health monitoring of a client system 500 using predictive functions, according to an example embodiment. In this embodiment, client system 500 may dynamically monitor the health of its devices using at least two different predictive functions that use time as an input variable. The relationship between different severity levels, including a notice severity alert 504, a warning severity alert 506, and a critical severity alert 508, over time 501 for two potential problems (e.g., CPU usage impact and certificate expiration impact) in accordance with the techniques of the example embodiments are shown.

For example, diagnostic results associated with a certificate expiration 510 having an associated severity level of notice alert 504 and a CPU usage level 520 (e.g., high CPU usage) having an associated severity level of warning alert 506 may be generated based on applying datasets to code modules at a first time point 502 (e.g., “Now” on time axis 501). These diagnostic results 510, 520 also include generated predictive functions that use time as an input variable mapped to the severity level of the potential problem. The predictive functions for CPU usage level and certificate expiration are able to generate updated diagnostic results and associated severity levels based on changes in time (i.e., changes to the input variable). These updated diagnostic results and/or severity levels are generated without applying new datasets.

In this embodiment, by providing the predictive function a new input of second time point 503 (e.g., “Tuesday” on time axis 501) the predictive function for CPU usage level generates an updated diagnostic result 522 (e.g., low CPU usage) having an associated severity level of notice alert 504 based on the change to the input variable (i.e., time). In this case, updated diagnostic result 522 has an associated severity level that changes from warning alert 506 at first time point 502 to notice alert 504 at second time point 503 based on changing the value of time as the input variable for the predictive function.

At a third time point 505 (e.g., “Friday” on time axis 501), the predictive function for certificate expiration generates an updated diagnostic result 512 having an associated severity level of notice alert 504 based on the change to the input variable (i.e., time). In this case, updated diagnostic result 512 has the same associated severity level (e.g., notice alert 504) at first time point 502 and third time point 505. However, by changing the value of time as the input variable for the predictive function for certificate expiration to a fourth time point 507 (e.g., “Saturday” on time axis 510), the predictive function generates an updated diagnostic result 514 having an associated severity level of critical alert 508. That is, the potential problem of certificate expiration changes from notice alert 504 at first time point 501 and third time point 505 to critical alert 508 at fourth time point 507 based on changing the value of time as the input variable for the predictive function. With this arrangement, predictive functions may be used for dynamically monitoring and predicting potential problems with one or more devices of client system 500 based on changes to the input variable (e.g., time).

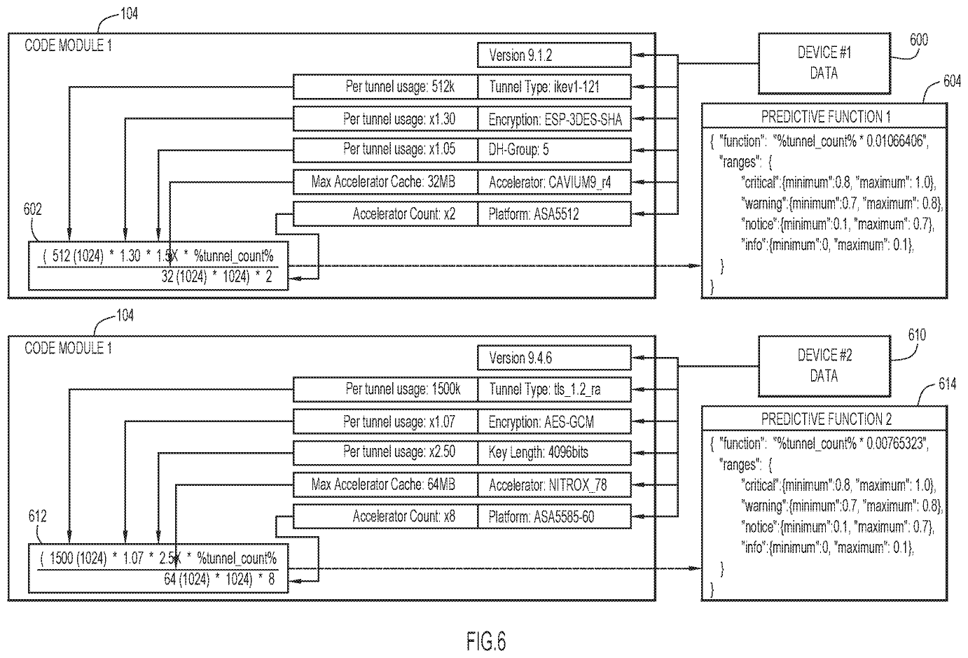

Referring now to FIG. 6, generation of customized predictive functions based on characteristics of a client device are shown according to an example embodiment. In some embodiments, a code module may generate predictive functions that are customized or “bespoke” to the particular characteristics and/or properties of a client device. In this embodiment, datasets for two different client devices are shown being applied to the same first code module 104, which generates a different predictive function for each client device.

For example, a first dataset 600 that includes operational data, configuration information, and other characteristics associated with a first client device (e.g., first device 154) is applied to first code module 104. In this embodiment, first code module 104 uses the operational data, configuration information, and other characteristics, including, but not limited to: tunnel type and usage information, encryption levels or types, software versions, platform information, accelerator information, and/or other configuration, operational or telemetry data, and characteristics of the client device, to generate one or more constant values according to a first formula 602.

Additionally, first formula 602 includes a variable (e.g., tunnel count) that becomes the input variable for a first predictive function 604 generated by first code module 104 for the first client device. In this embodiment, first predictive function 604 is a function of the tunnel count input variable multiplied by the determined constant value (e.g., 0.01066406) that is customized or bespoke to the first client device based on first dataset 600.

A second dataset 610 that includes operational data, configuration information, and other characteristics associated with a second client device (e.g., second device 156) is also applied to first code module 104. In this embodiment, the second client device is different than the first client device, and, therefore, second dataset 610 has different operational data, configuration information, and other characteristics compared with first dataset 600. First code module 104 uses the operational data, configuration information, and other characteristics of the second client device included in second dataset 610 to generate one or more constant values according to a second formula 612.

In this embodiment, because the second client device is different from the first client device, second formula 612 includes different constant values that are specific to the operational data, configurations and/or characteristics of the second client device. Second formula 612 includes the same input variable (e.g., tunnel count) as first formula 602 that becomes the input variable for a second predictive function 614 generated by first code module 104 for the second client device. In this embodiment, second predictive function 614 is a function of the tunnel count input variable multiplied by the determined constant value (e.g., 0.00765323) that is customized or bespoke to the second client device based on second dataset 610.

With this arrangement, two different client devices have different customized or bespoke predictive functions (e.g., first predictive function 604 and second predictive function 614) that are tailored to each client device and its particular operational or telemetry data, configuration, and other characteristics. Both predictive functions 604, 614 include the same input variable (e.g., tunnel count), but the impact of changes to that input variable will be different for each client device because of different constant values determined by first code module 104 based on the dataset for each client device. That is, because first predictive function 604 includes a larger constant value than second predictive function 614, changes to the value for the input variable (e.g., tunnel count) will have a larger impact to the first client device than the second client device.

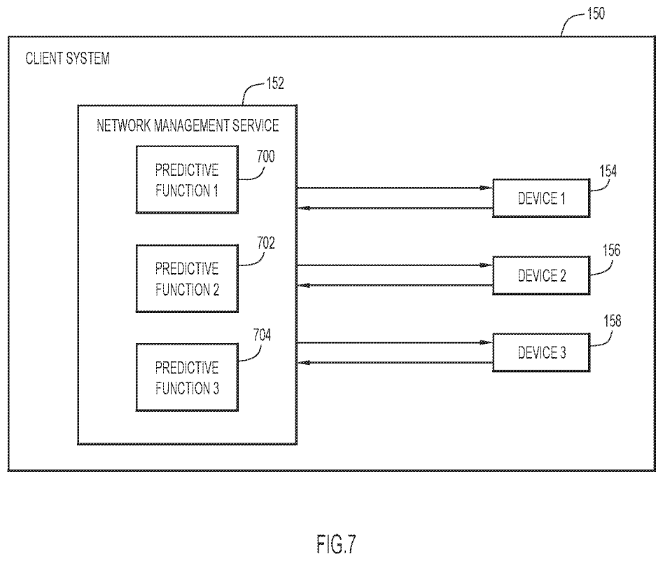

FIG. 7 illustrates client system 150 using predictive functions to dynamically monitor one or more devices according to an example embodiment. In some embodiments, client system 150 may have previously provided one or more datasets to automated problem detection and alerting system 100, which returned corresponding predictive functions generated based on the datasets, for example, as described above in reference to FIGS. 1-6. In this embodiment, network management service 152 at client system 150 includes a plurality of predictive functions, including a first predictive function 700, a second predictive function 702, and a third predictive function 704. Network management service 152 may use plurality of predictive functions 700, 702, 704 to dynamically monitor and predict potential problems with one or more devices 154, 156, 158 at client system 150 based on changes to input variables associated with predictive functions 700, 702, 704.

For example, network management service 152 may query one or more of devices 154, 156, 158 to obtain current values for the input variables associated with one or more of plurality of predictive functions 700, 702, 704 to generate updated diagnostic results and/or associated severity levels for the devices, without providing new datasets to automated problem detection and alerting system 100. Using plurality of predictive functions 700, 702, 704, network management service 152 may poll devices 154, 156, 158 at any desired interval or periodicity to determine current diagnostic results and/or severity levels for potential problems at client system 150.

The predictive functions of the present embodiments allow network management service 152 and/or client system 150 to be alerted to changes in the severity levels of alerts associated with potential problems based on changes to the input variables associated with plurality of predictive functions 700, 702, 704 that may happen in real-time, without requiring additional or subsequent diagnostic scans of devices 154, 156, 158 at client system 150 by automated problem detection and alerting system 100.

Additionally, as described above, network management service 152 may also use plurality of predictive functions 700, 702, 704 to simulate potential states of devices 154, 156, 158, as well as the potential impact to client system 150, by using test or model values for the input variables associated with the predictive functions. With this arrangement, parameters associated with different network conditions may be used as inputs to the predictive functions to forecast or simulate changes to devices 154, 156, 158 and/or client system 150.

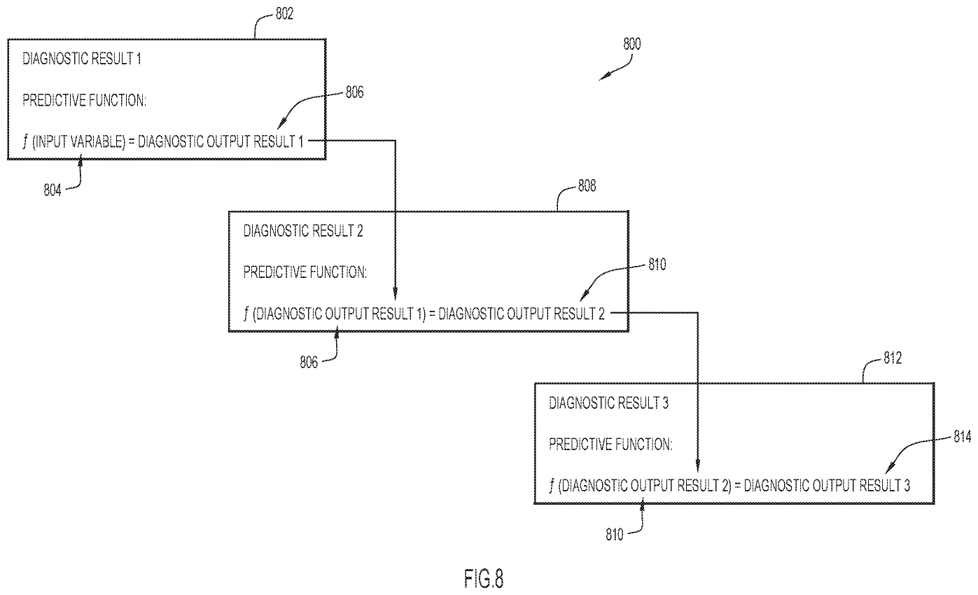

In some embodiments, multiple predictive functions may be chained together such that the output from one predictive function is used as an input variable for another predictive function. Referring now to FIG. 8, a diagram illustrating chained predictive functions is shown according to an example embodiment. In this embodiment, a predictive function chain 800 includes three predictive functions, including a first predictive function 802, a second predictive function 808, and a third predictive function 812.

First predictive function 802 is a function of a first input variable 804 and returns a first diagnostic output result 806. This first diagnostic output result 806 is then used as the input variable for second predictive function 808. Using first diagnostic output result 806 as its input variable, second predictive function 808 returns a second diagnostic output result 810. This second diagnostic output result 810 may then be used as the input variable for third predictive function 812. Using second diagnostic output result 810 as its input variable, third predictive function 812 returns a third diagnostic output result 814. With this arrangement, predictive function chain 800 can simulate how client devices and/or a client system will behave when network conditions change. By chaining multiple predictive functions together in this manner, the overall impact of a change to one input variable that may affect other potential problems or issues at a client system may be simulated and understood.

FIG. 8 may be explained with reference to an example of input variables and outputs for predictive function chain 800. For example, first predictive function 802 may be associated with how CPU usage will be affected as a number of access lists (ACLs) on a device increases or decreases. In this example, first input variable 804 for first predictive function 802 is a number of ACLs and first diagnostic output result 806 is CPU usage. Second predictive function 808 may be associated with how packet loss severity through a device will increase or decrease as the CPU usage of the device increases or decreases. In this example, second predictive function 808 uses the value of CPU usage determined as first diagnostic output result 806 of first predictive function 802 as its input variable to generate second diagnostic output result 810 that is a value for packet loss percentage.

Similarly, this second diagnostic output result 810 (e.g., packet loss percentage) may be used as the input variable for third predictive function 812. Third predictive function 812 may be associated with how the client's network will be impacted by the packet loss caused by the device. In this example, third predictive function 812 uses the value of packet loss percentage determined as second diagnostic output result 810 of second predictive function 808 as its input variable to generate third diagnostic output result 814 that is a severity level of the impact of the packet loss percentage on the network. With this arrangement, predictive function chain 800 provides an accurate forecast or simulation showing the impact to the network (i.e., severity level determined as third diagnostic output result 814) based on increases or decreases in the number of ACLs (i.e., changes to first input variable 804 for first predictive function 802), and how those increases or decreases will change CPU usage (i.e., first diagnostic output result 806) and lead to packet losses (i.e., second diagnostic output result 810).

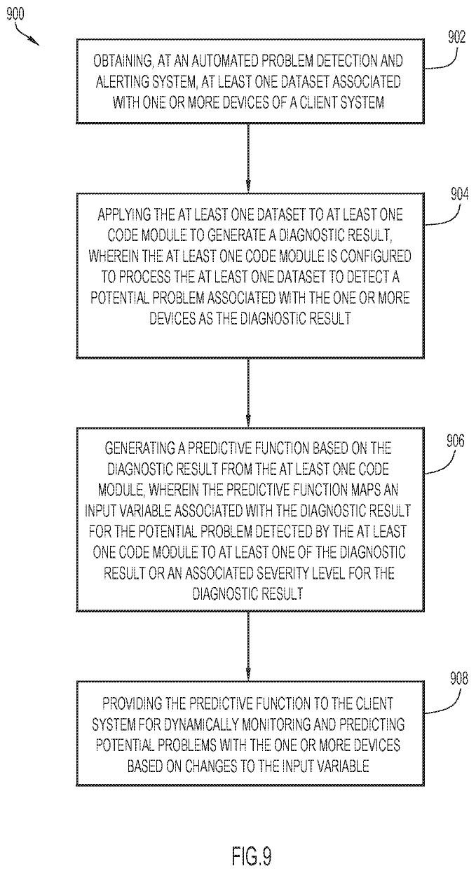

Referring now to FIG. 9, a flowchart of a method 900 is shown that illustrates operations of process for generating a predictive function according to an example embodiment. In some embodiments, method 900 may be performed by automated problem detection and alerting system 100. In this embodiment, method 900 may begin at an operation 902 where an automated problem detection and alerting system obtains or receives at least one dataset associated with one or more devices of a client system. For example, as shown in FIG. 1, automated problem detection and alerting system 100 may obtain dataset 110 for first device 104 from client system 150.

Next, at an operation 904, method 900 includes applying the at least one dataset to at least one code module to generate a diagnostic result and an associated severity level for the diagnostic result. The at least one code module is configured to process the at least one dataset to detect a potential problem associated with the one or more devices as the diagnostic result. For example, as shown in FIG. 2, dataset 110 for first device 154 of client system 150 may be applied to first code module 104 to generate output 200 that includes diagnostic result 202 with associated severity level 204 that includes any issues found in dataset 110 as a potential problem with first device 154.

At an operation 906, method 900 includes generating a predictive function based on the diagnostic result from the at least one code module. The predictive function generated at operation 906 maps an input variable associated with the diagnostic result for the potential problem detected by the at least one code module to at least one of the diagnostic result or the associated severity level for the diagnostic result. For example, as shown in FIG. 2, predictive function 206 maps input variable 208 associated with diagnostic result 202 for the potential problem with first device 154 detected by first code module 104 to at least one of diagnostic result 202 or the associated severity level 204 for diagnostic result 202.

Method 900 may further include an operation 908. At operation 908, the generated predictive function from operation 906 is provided to the client system. With the predictive function, the client system may dynamically monitor and predict potential problems with the one or more devices based on changes to the input variable for the predictive function. For example, as shown in FIG. 3, automated problem detection and alerting system 100 may provide or transmit predictive function 206 to client system 150, where network management service 152 may use it to monitor and/or predict potential problems associated with devices 154, 156, 158.

Additionally, method 900 may be repeated with additional datasets (e.g., from different devices at the client system) and/or with additional code modules configured to detect different types of potential problems and generate predictive functions associated with those devices and/or problems.

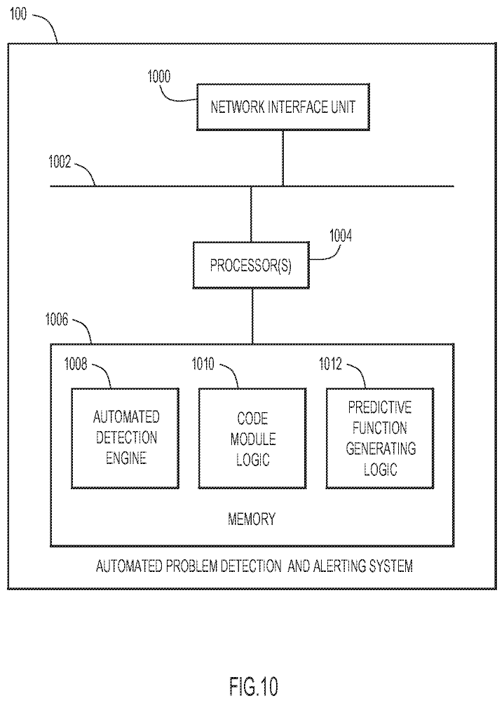

Referring now to FIG. 10, an example of a computer system upon which the embodiments presented may be implemented is shown. In this embodiment, the computer system may be programmed to implement automated problem detection and alerting system 100 (e.g., including automated detection engine 102 and plurality of code 104, 106, 108), as shown in FIG. 1, for implementing the techniques for dynamic health monitoring of a client system using predictive functions described herein. Automated problem detection and alerting system 100 includes a network interface unit 1000, such as one or more network interface cards that enable network connectivity. Network interface unit 1000 provides a two-way data communication coupling to a network link that is connected to, for example, communications network 112 shown in FIG. 1, such as the Internet, or to a local area network (LAN) or other network. Wireless links may also be implemented. In any such implementation, network interface unit 1000 provides/transmits and obtains/receives electrical, electromagnetic or optical signals that carry digital data streams representing various types of information.

Automated problem detection and alerting system 100 also includes a bus 1002 or other communication mechanism for communicating information, and a processor 1004 coupled with network interface unit 1000 and bus 1002 for processing the information. While the figure shows a single block 1004 for a processor, it should be understood that the processor 1004 may represent a plurality of processing cores, each of which can perform separate processing. Automated problem detection and alerting system 100 also includes a main memory 1006, such as a random access memory (RAM) or other dynamic storage device (e.g., dynamic RAM (DRAM), static RAM (SRAM), and synchronous DRAM (SD RAM)), coupled to the bus 1002 for storing information and instructions to be executed by processor 1004. In addition, the main memory 1006 may be used for storing temporary variables or other intermediate information during the execution of instructions by the processor 1004.

Memory 1006 may include ROM of any type now known or hereinafter developed, RAM of any type now known or hereinafter developed, magnetic disk storage media devices, tamper-proof storage, optical storage media devices, flash memory devices, electrical, optical, or other physical/tangible memory storage devices. In general, the memory 1006 may comprise one or more tangible (non-transitory) computer readable storage media (e.g., a memory device) encoded with software comprising computer executable instructions and when the software is executed (by the processor 1004) it is operable to perform the operations described herein.

The memory 1006 stores instructions for an automated detection engine 1008, that when executed by the processor 1004, cause the processor to perform the operations of automated detection engine 102 described herein. The memory 1006 also stores instructions for operations associated with the techniques for generating predictive functions described herein. For example, memory 1006 may further include a code module logic 1010 and a predictive function generating logic 1012.

In an example embodiment, code module logic 1010 may cause processor 1004 to perform operations associated with generating the one or more code modules to detect potential problems with one or more devices of a client system. For example, code module logic 1010 may cause processor 1004 to perform operations to generate one or more of plurality of code modules 104, 106, 108. Additionally, predictive function generating logic 1012 may cause processor 1004 to generate one or more of the predictive functions described herein in reference to FIGS. 1-9 above.

The techniques of the example embodiments described herein provides a mechanism in the form of a predictive function that can take in a variety of different attributes as input variables to dynamically predict network impacts and overall health of a network based on changes to the input variables. Additionally, predictive functions may be chained together in a predictive function chain to predict or simulate how changes to different system functions interact with each other and affect the overall health of a client system or network.

The present embodiments provide techniques to allow for a prediction of a future problem in a client system or network. Using the techniques provided herein, an automated detection engine can be run once against a dataset and using the resulting predictive functions, the client system can feed different input variables (such as time, telemetry, load, etc.) into the predictive function to predict how a problem will change into the future or as different input variables associated with devices at a client system or network change.

In one form, a computer-implemented method is provided that includes obtaining, at an automated problem detection and alerting system, at least one dataset associated with one or more devices of a client system; applying the at least one dataset to at least one code module to generate a diagnostic result, wherein the at least one code module is configured to process the at least one dataset to detect a potential problem associated with the one or more devices as the diagnostic result; generating a predictive function based on the diagnostic result from the at least one code module, wherein the predictive function maps an input variable associated with the diagnostic result for the potential problem detected by the at least one code module to at least one of the diagnostic result or an associated severity level for the diagnostic result; and providing the predictive function to the client system for dynamically monitoring and predicting potential problems with the one or more devices based on changes to the input variable.

In another form, a non-transitory computer readable storage media encoded with instructions is provided that, when executed by a processor of an automated problem detection and alerting system, cause the processor to perform operations comprising: obtaining at least one dataset associated with one or more devices of a client system; applying the at least one dataset to at least one code module to generate a diagnostic result, wherein the at least one code module is configured to process the at least one dataset to detect a potential problem associated with the one or more devices as the diagnostic result; generating a predictive function based on the diagnostic result from the at least one code module, wherein the predictive function maps an input variable associated with the diagnostic result for the potential problem detected by the at least one code module to at least one of the diagnostic result or an associated severity level for the diagnostic result; and providing the predictive function to the client system for dynamically monitoring and predicting potential problems with the one or more devices based on changes to the input variable.

In still another form, an apparatus is provided comprising a network interface unit configured to communicate with an automated detection engine that processes datasets associated with devices of a client system to detect potential problems associated with the one or more devices; a memory; and a processor coupled to the network interface unit and memory, the processor configured to: obtain at least one dataset associated with one or more devices of a client system; apply the at least one dataset to at least one code module to generate a diagnostic result, wherein the at least one code module is configured to process the at least one dataset to detect a potential problem associated with the one or more devices as the diagnostic result; generate a predictive function based on the diagnostic result from the at least one code module, wherein the predictive function maps an input variable associated with the diagnostic result for the potential problem detected by the at least one code module to at least one of the diagnostic result or an associated severity level for the diagnostic result; and provide the predictive function to the client system for dynamically monitoring and predicting potential problems with the one or more devices based on changes to the input variable.

The above description is intended by way of example only. The present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Although the techniques are illustrated and described herein as embodied in one or more specific examples, it is nevertheless not intended to be limited to the details shown, since various modifications and structural changes may be made within the scope and range of equivalents of this disclosure.

What is claimed is:

1. A computer-implemented method comprising:
obtaining, at an automated problem detection and alerting system, at least one dataset associated with one or more devices of a client system;
applying the at least one dataset to at least one code module to generate a diagnostic result wherein the at least one code module is configured to process the at least one dataset to detect a potential problem associated with the one or more devices as the diagnostic result;
generating a predictive function based on the diagnostic result from the at least one code module, wherein the predictive function maps an input variable associated with the diagnostic result for the potential problem detected by the at least one code module to at least one of the diagnostic result or an associated severity level for the diagnostic result; and
providing the predictive function to the client system for dynamically monitoring and predicting potential problems with the one or more devices based on changes to the input variable.

2. The method of claim 1, wherein the predictive function is configured to generate an updated diagnostic result with an associated severity level based on a change to the input variable.

3. The method of claim 2, wherein the predictive function is operable to generate the updated diagnostic result and the associated severity level without applying a new dataset to the at least one code module.

4. The method of claim 1, wherein the input variable includes at least one parameter measured in real-time at the client system.

5. The method of claim 1, wherein the input variable includes at least one parameter that simulates a potential state of the one or more devices of the client system.

6. The method of claim 1, further comprising:
generating a plurality of predictive functions, wherein each predictive function is associated with a particular code module configured to generate a specific diagnostic result; and
wherein each predictive function maps a different input variable associated with the specific diagnostic result for a potential problem detected by the particular code module to at least one of the specific diagnostic result or an associated severity level for the specific diagnostic result.

7. The method of claim 1, further comprising:
generating at least one chained predictive function, wherein the chained predictive function includes an input variable that is a diagnostic result output from at least one other predictive function.

8. A non-transitory computer readable storage media encoded with instructions that, when executed by a processor of an automated problem detection and alerting system, cause the processor to perform operations comprising:
obtaining at least one dataset associated with one or more devices of a client system;
applying the at least one dataset to at least one code module to generate a diagnostic result, wherein the at least one code module is configured to process the at least one dataset to detect a potential problem associated with the one or more devices as the diagnostic result;
generating a predictive function based on the diagnostic result from the at least one code module, wherein the predictive function maps an input variable associated with the diagnostic result for the potential problem detected by the at least one code module to at least one of the diagnostic result or an associated severity level for the diagnostic result; and
providing the predictive function to the client system for dynamically monitoring and predicting potential problems with the one or more devices based on changes to the input variable.

9. The non-transitory computer readable storage media of claim 8, wherein the predictive function is configured to generate an updated diagnostic result with an associated severity level based on a change to the input variable.

10. The non-transitory computer readable storage media of claim 9, wherein the predictive function is operable to generate the updated diagnostic result and the associated severity level without applying a new dataset to the at least one code module.

11. The non-transitory computer readable storage media of claim 8, wherein the input variable includes at least one parameter measured in real-time at the client system.

12. The non-transitory computer readable storage media of claim 8, wherein the input variable includes at least one parameter that simulates a potential state of the one or more devices of the client system.

13. The non-transitory computer readable storage media of claim 8, wherein the instructions further cause the processor to perform operations comprising:
generating a plurality of predictive functions, wherein each predictive function is associated with a particular code module configured to generate a specific diagnostic result; and
wherein each predictive function maps a different input variable associated with the specific diagnostic result for a potential problem detected by the particular code module to at least one of the specific diagnostic result or an associated severity level for the specific diagnostic result.

14. The non-transitory computer readable storage media of claim 8, wherein the instructions further cause the processor to perform operations comprising:
generating at least one chained predictive function, wherein the chained predictive function includes an input variable that is a diagnostic result output from at least one other predictive function.

15. An apparatus comprising:
a network interface unit configured to communicate with an automated detection engine that processes datasets associated with devices of a client system to detect potential problems associated with the one or more devices;
a memory; and
a processor coupled to the network interface unit and the memory, the processor configured to:
obtain at least one dataset associated with one or more devices of a client system;
apply the at least one dataset to at least one code module to generate a diagnostic result, wherein the at least one code module is configured to process the at least one dataset to detect a potential problem associated with the one or more devices as the diagnostic result;
generate a predictive function based on the diagnostic result from the at least one code module, wherein the predictive function maps an input variable associated with the diagnostic result for the potential problem detected by the at least one code module to at least one of the diagnostic result or an associated severity level for the diagnostic result; and
provide the predictive function to the client system for dynamically monitoring and predicting potential problems with the one or more devices based on changes to the input variable.

16. The apparatus of claim 15, wherein the predictive function is configured to generate an updated diagnostic result with an associated severity level based on a change to the input variable.

17. The apparatus of claim 16, wherein the predictive function is operable to generate the updated diagnostic result and the associated severity level without applying a new dataset to the at least one code module.

18. The apparatus of claim 15, wherein the input variable includes at least one parameter measured in real-time at the client system or that simulates a potential state of the one or more devices of the client system.

19. The apparatus of claim 15, wherein the processor to further configured to:
generate a plurality of predictive functions, wherein each predictive function is associated with a particular code module configured to generate a specific diagnostic result; and
wherein each predictive function maps a different input variable associated with the specific diagnostic result for a potential problem detected by the particular code module to at least one of the specific diagnostic result or an associated severity level for the specific diagnostic result.

20. The apparatus of claim 15, wherein the processor to further configured to:
generate at least one chained predictive function, wherein the chained predictive function includes an input variable that is a diagnostic result output from at least one other predictive function.
